(19) United States
(12) Patent Application Publication
(10) Pub. No.: US 2011/0074927 A1
(43) Pub. Date: Mar. 31, 2011

(54) METHOD FOR DETERMINING EGO-MOTION OF MOVING PLATFORM AND DETECTION SYSTEM

(76) Inventors: Ming-Hwei Perng, Hsinchu City (TW); Chih-Ting Chen, Tainan City (TW)

(21) Appl. No.: 12/877,447

(22) Filed: Sep. 8, 2010

(30) Foreign Application Priority Data
Sep. 29, 2009 (TW) 098132870

(51) Int. Cl. H04N 13/02; G06K 9/00

(52) U.S. Cl. 348/46; 382/107; 348/E13.074

(57) ABSTRACT

A method for determining ego-motion of a moving platform and a system thereof are provided. The method includes: using a first lens to capture a first and a second left image at a first and a second time, and using a second lens to capture a first and a second right image; segmenting the images into first left image areas, first right image areas, second left image areas, and second right image areas; comparing the first left image areas and the first right image areas, the second left image areas and the second right image areas, and the first right image areas and the second right image areas, so as to find plural common areas; selecting N feature points in the common areas to calculate depth information at the first and the second time, and determining the ego-motion of the moving platform between the first time and the second time.

### BACKGROUND OF THE INVENTION

1. Cross-Reference to Related Application

This application claims the benefit of Taiwan Patent Application No. 098132870, filed on Sep. 29, 2009, which is hereby incorporated by reference for all purposes as if fully set forth herein.

2. Field of Invention

The invention relates to a method for determining the ego-motion of a moving platform and a detection system thereof, and more particularly to a method for determining the ego-motion of a moving platform and a detection system thereof that use a movable and calibrated stereo camera as a photograph device and use image processing methods such as color information and feature matching.

3. Related Art

An early detection technology of a moving object is mainly applied to a surveillance system, for example, for building surveillance or traffic surveillance, in which a single camera is placed at a fixed position for detecting a suspicious moving object.

Normally, three methods are employed for a fixed camera to detect a moving object, including: (1) a background subtraction method, (2) a frame differencing method, and (3) an optical flow method.

Correction through the background subtraction method is as follows. The background compensation method is a method for establishing a dynamic background proposed in recent years to be adapted to a dynamic environment. In 1997, Russel, S. et al. proposed a method of continually updating the background by using a Gaussian mixture model. Alternatively, images shot continually are used to calculate the ego-motion of the camera, so as to update the background, which is then subtracted from an input image to obtain the moving object.

Correction through the frame differencing method is as follows. After the ego-motion of the camera is calculated, the image shot at tₙ₋₁ is compensated directly; as the background does not move, the motion of the background on the image is consistent with the motion of the camera. After the compensation, the backgrounds in two images shot at tₙ₋₁ and tₙ completely overlap each other, so the background can be completely removed through the frame differencing method; however, the motion of the projection of the moving object on the image is inconsistent with the motion of the camera, and the projection remains after the differencing operation, so that the moving object is found.

Correction through the optical flow method is as follows. Similar to the correction through the frame differencing method, first the ego-motion of the camera is estimated to compensate the image shot at tₙ₋₁, and then an optical flow field of each pixel in the image is calculated, and the moving object can be found by analyzing the optical flow fields.

However, for any one of the detection methods, when being applied to a moving platform, the detection method must be achieved through the compensation to the ego-motion of the camera. As the detection system is disposed on the moving platform, and the background changes with time instead of being almost the same in the images continually shot with the fixed camera, modification is needed in all the detection methods described above.

### SUMMARY OF THE INVENTION

Accordingly, in one aspect, the invention is directed to a method for determining the ego-motion of a moving platform, so as to solve the above problems.

According to an embodiment, the method of the invention includes the following steps. Firstly, a first lens is used to capture a first left image and a second left image at a first time and a second time respectively, and a second lens is used to capture a first right image and a second right image at the first time and the second time respectively; then, the first left image is segmented into a plurality of first left image areas, the first right image is segmented into a plurality of first right image areas, the second left image is segmented into a plurality of second left image areas, and the second right image is segmented into a plurality of second right image areas, respectively.

Further, the first left image areas and the first right image areas, the second left image areas and the second right image areas, and the first right image areas and the second right image areas are compared respectively to find a plurality of common areas corresponding to the first left image, the first right image, the second left image, and the second right image; then, N feature points are selected in the common areas, where N is a positive integer; next, the N feature points are used to calculate a first depth information at the first time and a second depth information at the second time; finally, the ego-motion of the moving platform between the first time and the second time is determined according to the first depth information and the second depth information.

In another aspect, the invention is directed to a detection system, for determining the ego-motion of a moving platform.

According to an embodiment, the detection system of the invention includes a moving platform, a stereo camera including a first lens and a second lens, and a processing module. The first lens is disposed on the moving platform, and captures a first left image and a second left image at a first time and a second time respectively; the second lens is disposed on the moving platform, and captures a first right image and a second right image at the first time and the second time respectively.

Further, the processing module is connected to the first lens and the second lens respectively, for receiving the first left image, the second left image, the first right image, and the second right image. The processing module segments the first left image into a plurality of first left image areas, segments the first right image into a plurality of first right image areas, segments the second left image into a plurality of second left image areas, and segments the second right image into a plurality of second right image areas; the processing module compares the first left image areas and the first right image areas, the second left image areas and the second right image areas, and the first right image areas and the second right image areas, so as to find a plurality of common areas corresponding to the first left image, the first right image, the second left image, and the second right image; the processing module selects N feature points in the common areas, where N is a positive integer; the processing module uses the N feature points to calculate a first depth information at the first time and a second depth information at the second time; and the processing module determines the ego-motion of the moving platform between the first time and the second time according to the first depth information and the second depth information.

Compared with the prior art, the method for determining the ego-motion of a moving platform and the detection system of the invention use the stereo camera capable of obtaining the depth information to calculate the ego-motion of the cameras, so that correct estimation can be achieved even in scenes with depth changes violently. However, two images must be corresponded with each other when the stereo camera is used. Therefore, in order to establish the correspondence between the two images faster, the correspondence of areas moving at a higher speed is established first, and then corresponding points are searched in the corresponding areas, and epipolar geometry is introduced to reduce the search range substantially.

Moreover, a truncated method is proposed for the moving object in a scene and errors in point correspondence, so as to eliminate the moving object through limited times of iteration. Thus, the calculated ego-motion is more precise. In addition, the algorithm for estimating the ego-motion is improved compared with the existing method, and an appropriate method is proposed for feature capturing by stereo camera and matching, so as to accelerate the calculation, and make the algorithm of the invention more useful. Therefore, the method for determining the ego-motion of a moving platform and the detection system of the invention have promising industrial application potential in the surveillance system market.

The advantages and spirit of the invention will be better understood with reference to the following detailed description and the accompanying drawings.

### BRIEF DESCRIPTION OF THE DRAWINGS

The invention will become more fully understood from the detailed description given herein below for illustration only, and thus are not limitative of the invention, and wherein:

FIG. 1 is a flow chart of a method for determining the ego-motion of a moving platform according to an embodiment of the invention;

FIG. 2 is a flow chart of the color segmentation according to an embodiment of the invention;

FIG. 3 is a schematic view of image comparison according to an embodiment of the invention; and

FIG. 4 is a schematic view of a detection system according to an embodiment of the invention.

### DETAILED DESCRIPTION OF THE INVENTION

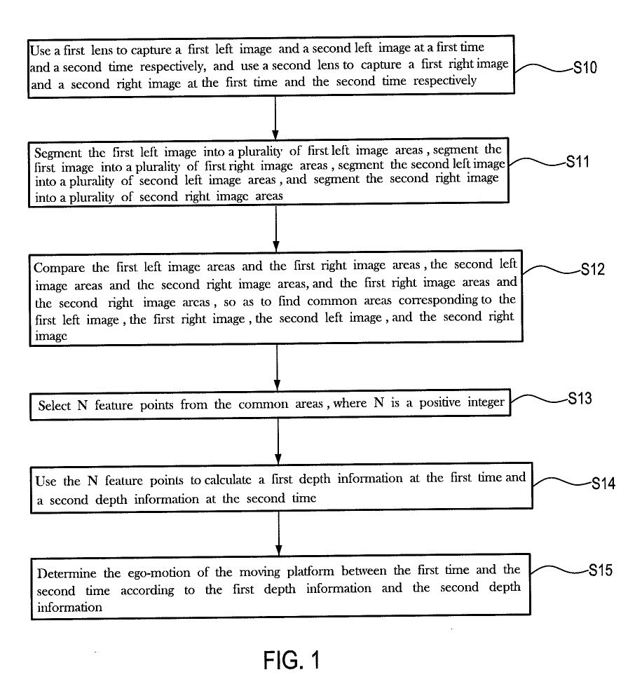

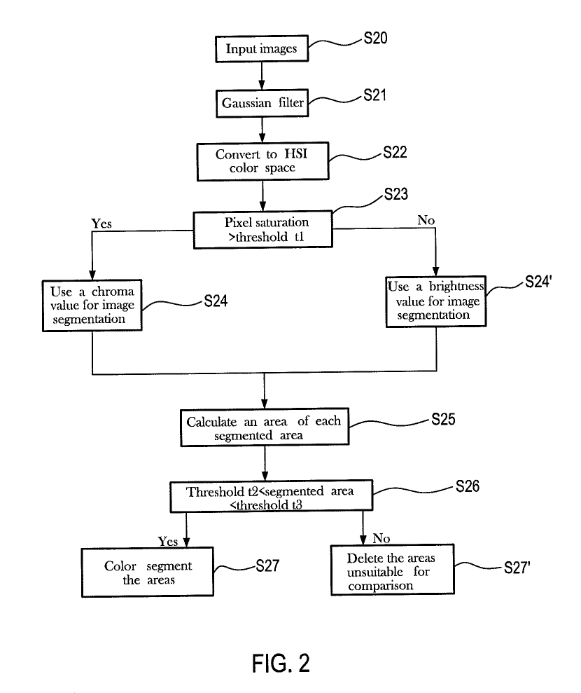

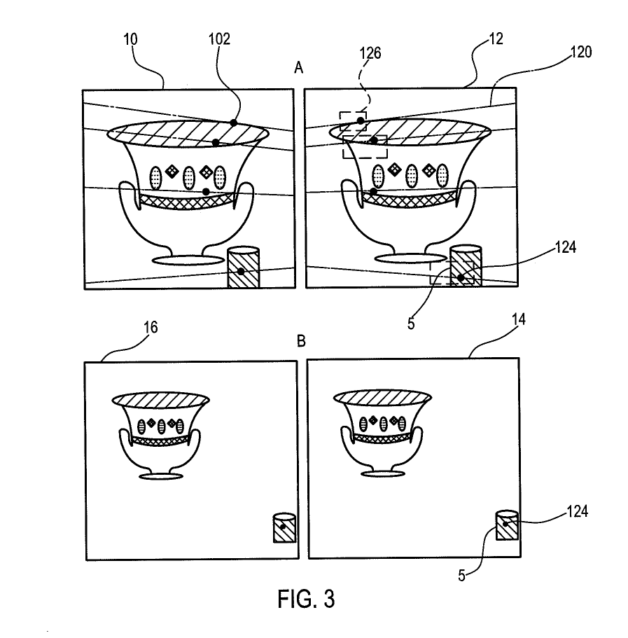

FIG. 1 is a flow chart of a method for determining the ego-motion of a moving platform according to an embodiment of the invention; FIG. 2 is a flow chart of color segmentation according to an embodiment of the invention; and FIG. 3 is a schematic view of image comparison according to an embodiment of the invention.

According to an embodiment, the method includes the following steps. Firstly, in Step S10, a first lens captures a first left image 10 and a second left image 16 at a first time A and a second time B respectively, and a second lens captures a first right image 12 and a second right image 14 at the first time A and the second time B respectively.

Next, in Step S11, the first left image 10 is segmented into a plurality of first left image areas, the first right image 12 is segmented into a plurality of first right image areas, the second left image 16 is segmented into a plurality of second left image areas, and the second right image 14 is segmented into a plurality of second right image areas, respectively.

In actual operations, in Step S11, the first left image 10, the first right image 12, the second left image 16, and the second right image 14 are color segmented. It should be noted that in Step S11, the segmentation does not need to be precise and correct, but must be performed at a high speed, and should avoid under segmentation. However, over segmentation is acceptable in Step S11.

Next, refer to FIG. 2. As shown in FIG. 2, the method for color segmentation includes the following steps. Firstly, in Step S20, the images are input; then, in Step S21, Gaussian filter is performed; then, in Step S22, the images are converted to HIS color space; next, in Step S23, it is determined whether pixel saturation is greater than a threshold t1; if positive, Step S24 is performed, in which a chroma value is used image segmentation; otherwise, Step S24′ is performed, in which a brightness value is used for image segmentation.

Then, in Step S25, an area of each segmented area is calculated; next, it is determined whether each segmented area is between thresholds t2 and t3, as shown in Step S26; too large or too small segmented areas adversely affect the subsequent image comparison. Therefore, if the determination result in Step S26 is positive, Step 27 is performed, in which the areas are color segmented; otherwise, Step S27′ is performed, in which the areas unsuitable for comparison are deleted.

Next, in Step S12, the first left image areas and the first right image areas, the second left image areas and the second right image areas, and the first right image areas and the second right image areas are compared respectively, so as to find common areas corresponding to the first left image 10, the first right image 12, the second left image 16, and the second right image 14.

Further, as shown in FIG. 3, epipolar lines are added into the first left image 10 and the first right image 12. As such, a point on the first right image 12 corresponding to a feature point 102 on the first left image 10 can be found by searching along the epipolar line 120, thereby greatly reducing the search range and the calculation amount. The range for searching the corresponding points in the stereo images can be simplified from two dimensions to one dimension based on the principle of discrete epipolar. The principle of discrete epipolar is a prior art, and will not be described in detail here.

In addition, the first left image 10 and the first right image 12 are two images shot at the same time (the first time A), so the comparison may be accelerated according to the principle of discrete epipolar. However, if a time difference exists between the first right image and the second right image, the principle of discrete epipolar is no longer applicable. Therefore, the invention uses a searching window 126 to reduce the search range and the calculation amount greatly.

In this embodiment, in S12, the first left image areas, the first right image areas, the second left image areas, and the second right image areas are compared in terms of the global geometrical constraints, local geometrical characteristics, and color properties. The global geometrical constraints include an epipolar constraint and an inter-area relative position constraint; the local geometrical characteristics include edges, area, centroid, width, height, depth-to-width ratio, and convex hull; and the color properties include color gradient values of area edges and color statistics inside the areas.

Further, in Step S13, N feature points are selected from the common areas, where N is a positive integer. In this embodiment, the N feature points are selected at a fixed interval in Step S13; for example, the feature points are selected at a fixed interval of 10 pixels. However, in actual applications, the N feature points may be selected according to factors such as experience accumulation, shot scenes, image pixels, and special requirements at a non-fixed interval, and the selection mode is not limited to this embodiment.

Then, in Step S14, the N feature points are used to calculate a first depth information at the first time A and a second depth information at the second time B. The depth information is distances from the N feature points to the first lens and the second lens. In actual applications, if a selected feature point is fixed in a scene, a change of the feature point relative to an origin of coordinates between the time A and B is a vector of the movement of the moving platform in a three-dimensional space relative to the feature point, that is, the ego-motion of the moving platform.

Finally, in Step S15, the ego-motion of the moving platform between the first time A and the second time B is determined according to the first depth information and the second depth information.

In this embodiment, the ego-motion parameters of the moving platform include a rotation matrix R and a translation matrix T. The rotation matrix R and the translation matrix T are calculated through a least square error method, and the calculation result is compared with the position changes of the feature points. The feature points with a too large difference are eliminated (for example, the feature point 124 in FIG. 3, that is, a feature point on a moving object 5, should be eliminated), and the least square error method is performed again. Optimal solutions of the rotation matrix R and the translation matrix T are obtained through limited times of iteration.

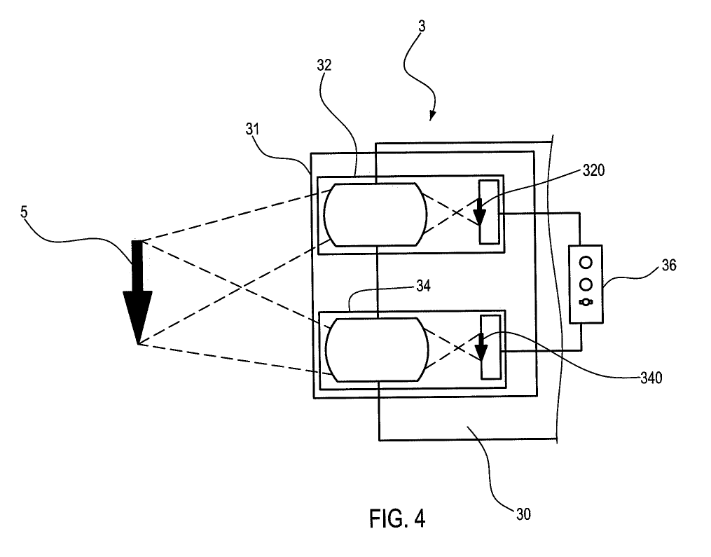

FIG. 4 is a schematic view of a detection system according to an embodiment of the invention.

Referring to FIG. 4, according to an embodiment, the detection system 3 of the invention includes a moving platform 30, a stereo camera 31 including a first lens 32 and a second lens 34, and a processing module 36.

Further, the first lens 32 is disposed on the moving platform 30, and captures at a first left image 320 and a second left image 320′ at a first time and a second time respectively; the second lens 34 is disposed on the moving platform 30, and captures a first right image 340 and a second right image 340′ at the first time and the second time respectively.

Further, the processing module 36 is connected to the first lens 32 and the second lens 34 respectively, for receiving the first left image 320, the second left image 320′, the first right image 340, and the second right image 340′.

The processing module 36 segments the first left image 320 into a plurality of first left image areas, segments the first right image 340 into a plurality of first right image areas, segments the second left image 320′ into a plurality of second left image areas, and segments the second right image 340′ into a plurality of second right image areas, respectively; the processing module 36 compares the first left image areas and the first right image areas, the second left image areas and the second right image areas, and the first right image areas and the second right image areas, so as to find a plurality of common areas corresponding to the first left image 320, the first right image 340, the second left image 320′, and the second right image 340′; the processing module 36 selects N feature points in the common areas, where N is a positive integer; the processing module 36 uses the N feature points to calculate a first depth information at the first time and a second depth information at the second time; and the processing module 36 determines the ego-motion of the moving platform 30 between the first time and the second time according to the first depth information and the second depth information.

To sum up, the invention uses a stereo camera to estimate the ego-motion of the moving platform mainly because the stereo camera can obtain the depth information indispensable in the invention. The stereo camera provides the depth information by correctly establishing the stereo image correspondence. When the stereo camera is used, the range for searching the corresponding points in the stereo images can be simplified from two dimensions to one dimension based on the principle of discrete epipolar.

Moreover, considering the possibility of real-time operation and the main objective of the invention to solve the ego-motion rapidly, the comparison method corresponding to the stereo camera should use the local comparison method requiring a small calculation amount to provide the depth information, and the information is used to calculate the ego-motion and the ego-motion compensation according to the depth precisely.

Compared with the prior art, the method for determining the ego-motion of a moving platform and the detection system of the invention use the stereo camera capable of obtaining the depth information to calculate the ego-motion of the cameras, so that correct estimation can be achieved even in scenes with depth changes violently. Therefore, the method for determining the ego-motion of a moving platform and the detection system of the invention have promising industrial application potential in the surveillance system market.

The detailed description of the above preferred embodiments is intended to make the features and spirits of the invention more comprehensible, rather than to limit the scope of the invention. On the contrary, various modifications or equivalent arrangements shall fall within the appended claims of the invention. Therefore, the scope of the claims of the invention shall be construed in a most extensive way according to the above description, and cover all possible modifications and equivalent arrangements.

What is claimed is:

1. A method for determining ego-motion of a moving platform, comprising steps of:
(a) using a first lens to capture a first left image and a second left image at a first time and a second time respectively, and using a second lens to capture a first right image and a second right image at the first time and the second time respectively;
(b) segmenting the first left image into a plurality of first left image areas, segmenting the first right image into a plurality of first right image areas, segmenting the second left image into a plurality of second left image areas, and segmenting the second right image into a plurality of second right image areas, respectively by a processing module;
(c) comparing the first left image areas and the first right image areas, the second left image areas and the second right image areas, and the first right image areas and the second right image areas, respectively, so as to find a plurality of common areas corresponding to the first left image, the first right image, the second left image, and the second right image by a processing module;
(d) selecting N feature points in the common areas, wherein N is a positive integer by the processing module;
(e) using the N feature points to calculate a first depth information at the first time and a second depth information at the second time by the processing module; and
(f) determining the ego-motion of the moving platform between the first time and the second time according to the first depth information and the second depth information by the processing module.

2. The method according to claim 1, wherein in the step (b), the first left image, the first right image, the second left image, and the second right image are color segmented.

3. The method according to claim 1, wherein in the step (c), the first left image areas, the first right image areas, the second left image areas, and the second right image areas are compared in terms of global geometrical constraints, local geometrical characteristics, and color properties.

4. The method according to claim 3, wherein the global geometrical constraints comprise an epipolar constraint and an inter-area relative position constraint.

5. The method according to claim 3, wherein the local geometrical characteristics comprises edges, area, centroid, width, height, depth-to-width ratio, and convex hull.

6. The method according to claim 3, wherein the color properties comprise color gradient values of area edges and color statistics inside the areas.

7. The method according to claim 1, wherein in the step (d), the N feature points are selected at a fixed interval.

8. The method according to claim 1, wherein the depth information is distances between the N feature points and the first lens and between the N feature points and the second lens.

9. A detection system, comprising:
a moving platform;
a stereo camera including a first lens, disposed on the moving platform, for capturing a first left image and a second left image at a first time and a second time respectively, and a second lens, disposed on the moving platform, for capturing a first right image and a second right image at the first time and the second time respectively; and
a processing module, connected to the first lens and the second lens, for receiving the first left image, the second left image, the first right image, and the second right image, wherein the processing module segments the first left image into a plurality of first left image areas, segments the first right image into a plurality of first right image areas, segments the second left image into a plurality of second left image areas, and segments the second right image into a plurality of second right image areas, the processing module compares the first left image areas and the first right image areas, the second left image areas and the second right image areas, and the first right image areas and the second right image areas, so as to find a plurality of common areas corresponding to the first left image, the first right image, the second left image, and the second right image, the processing module selects N feature points in the common areas, N is a positive integer, the processing module uses the N feature points to calculate a first depth information at the first time and a second depth information at the second time, and the processing module determines the ego-motion of the moving platform between the first time and the second time according to the first depth information and the second depth information.

10. The detection system according to claim 9, wherein the processing module color segments the first left image, the first right image, the second left image, and the second right image.

11. The detection system according to claim 9, wherein the processing module compares the first left image areas, the first right image areas, the second left image areas, and the second right image areas in terms of global geometrical constraints, local geometrical characteristics, and color properties.

12. The detection system according to claim 11, wherein the global geometrical constraints comprise an epipolar constraint and an inter-area relative position constraint.

13. The detection system according to claim 11, wherein the local geometrical characteristics comprise edges, area, centroid, width, height, depth-to-width ratio, and convex hull.

14. The detection system according to claim 11, wherein the color properties comprise color gradient values of area edges and color statistics inside the areas.

15. The detection system according to claim 9, wherein the processing module selects the N feature points at a fixed interval.

16. The detection system according to claim 9, wherein the depth information is distances between the N feature points and the first lens and between the N feature points and the second lens.
